(19) United States
(12) Patent Application Publication
(10) Pub. No.: US 2004/0255679 A1
(43) Pub. Date: Dec. 23, 2004

(54) System and method of measuring and classifying the impacts inside a revolving mill used in mineral grinding

(76) Inventors: Waldo Marcelo Valderrama Reyes, Vina Del Mar (CL); Jorge Antonio Pontt Olivares, Vina Del Mar (CL); Luis Alberto Magne Ortega, Santiago (CL); Fernando Alberto Salgado Ibarra, Vina del Mar (CL); German Arnaldo Sepulveda Villalobos, Valparaiso (CL)

Correspondence Address: Daniel DeJoseph, F.L. Smidth Inc., 2040 Avenue C, Bethlehem, PA, 18017-2188, US

(21) Appl. No.: 10/769,269

(22) Filed: Jan. 30, 2004

(30) Foreign Application Priority Data
Jan. 31, 2003 (CL) 190-2003

(51) Int. Cl. G01H 11/00

(52) U.S. Cl. 73/649

(57) ABSTRACT

A system and method of measuring and detecting impacts occurring inside a mill, by recognizing patterns and classifying them according to their power levels, in order to operate the rotating mill in accordance with control parameters. Impacts are classified according to a Cartesian diagram, namely: a vertical axis for contacts between rocky material, and a horizontal axis for contacts between metallic material.

### CLAIM OF PRIORITY

This application claims foreign priority under 35 U.S.C. 119(a) from Chilean Application No 190-2003, filed Jan. 31, 2003.

1. Field of Application

The present invention refers to mineral grinding; more specifically, to a system and method of measuring and classifying the impacts inside a rotating mill and influencing the mill's operational control in a mineral grinding process.

2. Description of Prior Art

Mineral grinding is an important part in a mineral production line. This process is at times carried out with large revolving mills that use free metallic balls inside them as grinding means to facilitate the transfer of mechanical energy for wearing and fracturing the mineral. The inside of mills is lined with replaceable steel pieces called “lining”, the useful life of which to a great extent depends on the proper handling of the load, comprised of a mineral or minerals, the grinding means and water.

Existing grinding systems have disadvantages which limit their efficiency. The mill lining has a short useful life because the load impacts not only onto itself (“load cataract”), but also on the mill lining with such force that the grinding means and the mill's lining mechanically wear, causing a sub-utilization of the grinding mill's capacity, as well as periodical shut-downs and repairs, all of which increase the cost of the mineral grinding line.

A device called the “Electric Ear” (“EE”) was invented in the first half of the past century that estimates the volume of a mill's cavity occupied by minerals, grinding means and/or water which was comprised of a microphone that detected the general intensity of the noise near the mill, without distinguishing whether this noise was caused by impacts, noise from the natural overturning of the load or from an external and independent source. The only output of the EE is an electrical signal to the plant's control system.

Another prior art device (developed by the Universidad Federico Santa Maria Grinding Technological Center SAG and Electric Systems) is the “Impact Meter Prototype”, consisting of a plurality of flare-type acoustic sensors, with distorted frequency response, located in front of the “load foot” zone of the mill, which corresponds to the estimated contacting position of the moving load or load cataract. The sensors were connected to a main unit (in the power or control room) that used limited processing analog electronics to count impacts by comparing the voltage width of the sound signal to an only and variable threshold and to temperature, sending its output in the form of a current signal to the plant's control system.

However, none of the mentioned inventions allows a digital processing to achieve predictive signals, recognizing patterns, multi-threshold discrimination, expandable processing, among other characteristics, such as the inclusion of displays allowing to show the dynamic and on-line performance of mill operation.

### BRIEF DESCRIPTION OF THE INVENTION

The present invention, which is useful in operating a mill in accordance with control parameters, comprises a system and method of measuring the impacts taking place inside a mill, by recognizing and classifying impact patterns based on their force level.

Thus, through the present invention it is possible to detect and classify impacts within a mill that are the result of (a) a violent contact of massive metallic balls against the internal lining of the mill, (b) a violent contact between low mass metallic materials and large rocks against the internal lining of the mill, or (c) impacts likely to be the overturning action of the load on itself, by rocks as well as iron balls falling directly against the internal lining of the mill without impacting the internal lining. The present invention may also detect the violent contact of massive metallic and rocky material against the internal lining of the mill or the violent contact of small metallic and rocky material against the internal lining of the mill.

Therefore, an objective of the present invention is to deliver an impact meter and a means of impact measurement, the use of which reduce the excessive and fast wear of said linings.

Another objective of the present invention is to decrease the consumption of balls per ton of processed mineral, that is, decrease the use of grinding means.

A further objective of this invention is to stabilize mill operation by adding a source of new data to be used in process control decisions, which can allow for more efficient operation resulting in increased average processed tonnage, decreased operational singularities (shut-downs, oscillations in filling level, inspections of lining, etc.) in time, optimum use of electricity used in powering the mill's engine, and the adequate handling of the load in motion.

### BRIEF DESCRIPTION OF THE DRAWINGS

FIG. 1 is a schematic that shows the characteristics taken by the load cataract inside a mill which, as depicted, is rotating counter clockwise.

FIG. 2 is a basic block diagram of the general system of the present invention.

FIG. 3 is a schematic diagram of a preferred embodiment of the invention, considering the arrangement of the sensors in the mill.

FIGS. 4a-4d describe the different positions of the sensors, together with a front view of the mill.

FIGS. 5a-5h describe the different positions of the sensors, together with a side view of the mill.

FIGS. 6a-6b describe the operational layout of the sensors located by the mill, according to the direction of the mill, along with the appropriate load foot.

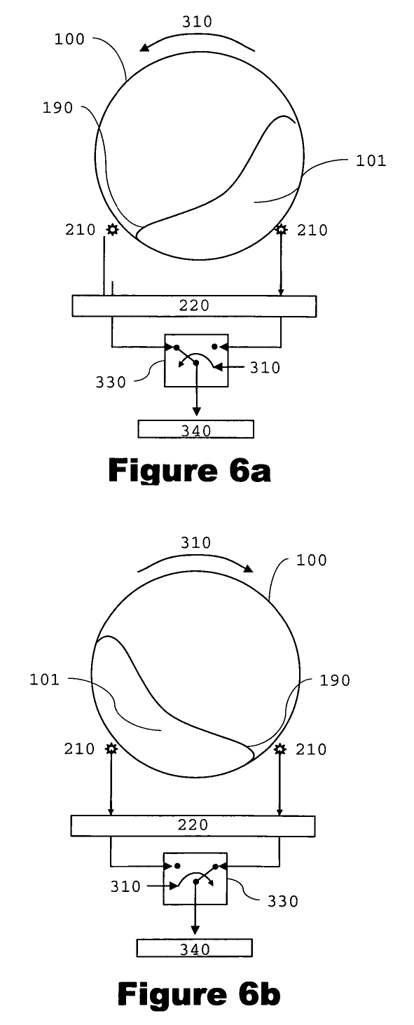

FIG. 7 is a Cartesian classification diagram representing the different characteristics of impacts, as per their energy.

FIG. 8 is a block diagram of the invention, for the signal flow of an example of the preferred embodiment of the invention, with four sensors.

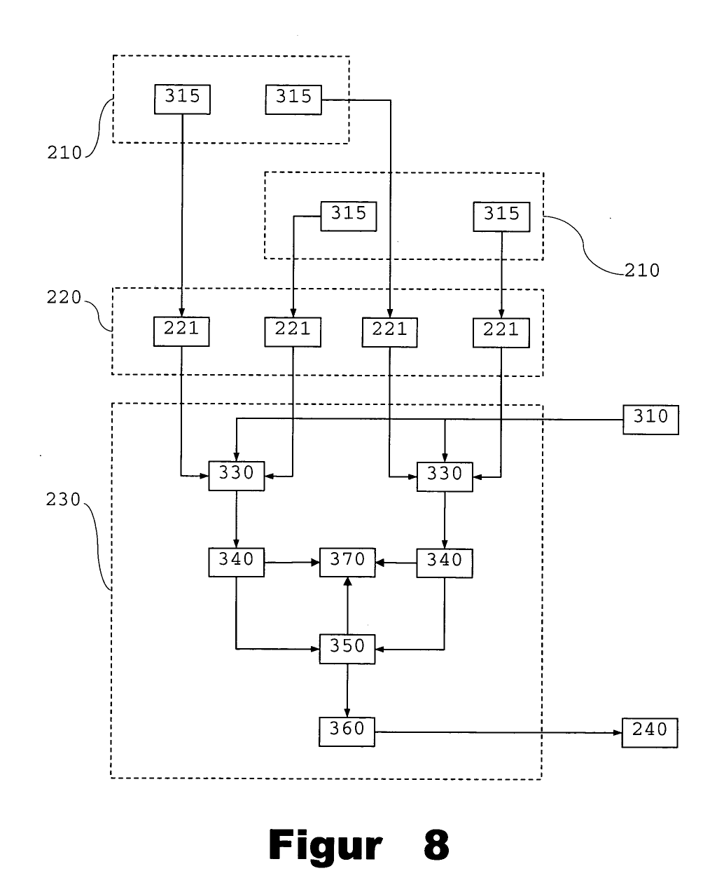

FIG. 9 represents a preferred embodiment of the invention's operational method to determine the characteristics of impacts as per their energy.

FIG. 10 describes an example of the display of the data the operator is provided with.

FIG. 11 describes the preferred embodiment of a mill operational method, based on the data delivered to the operator.

### DETAILED DESCRIPTION OF THE PREFERRED EMBODIMENTS

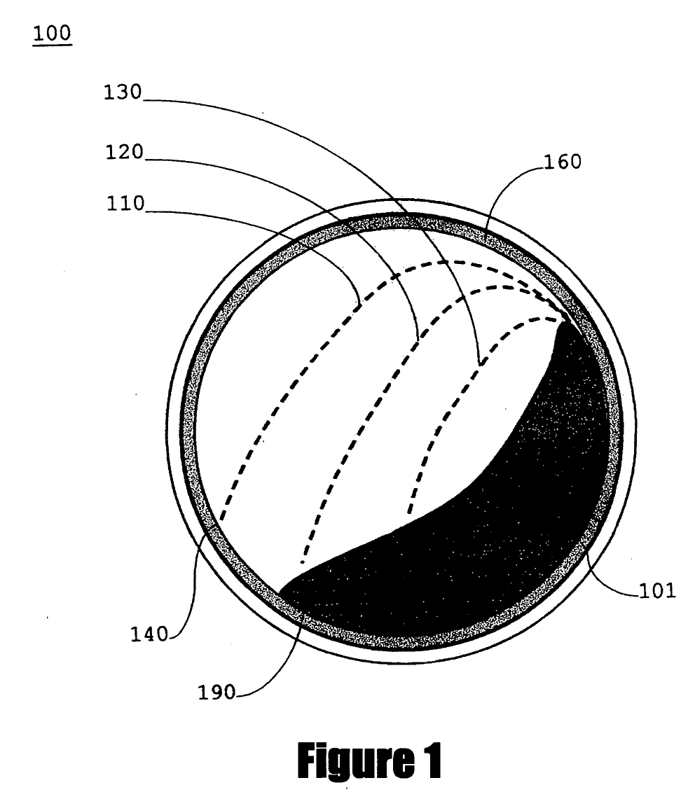

With reference to FIG. 1, mill 100 has a load 101 that may take various trajectories within mill 100, including a harmful trajectory 110, that causes load 101 to end up in a direct impact against the internal lining 160 of mill 100, which in FIG. 1 is shown as taking place at point 140; an insufficient trajectory 130 in which the load falls on itself prematurely and, finally, an optimum trajectory 120 for the load 101 to fall on itself.

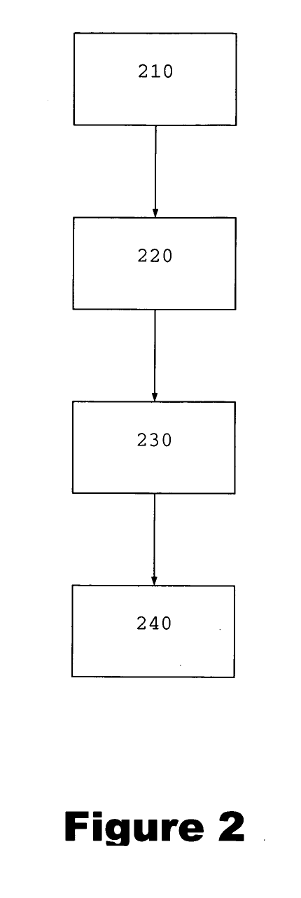

With reference to FIG. 2, the present invention is comprised of am impact sensing means comprising an array of sensors 210 which transmit their signals to a signal conditioner 220, connected to a signal processing means, such as a main unit 230, that processes said signals and sends out control signals to a control means to control the operation of the mill, according to the variables delivered by the processing means and which are based in part on the types of impact occurring inside the mill. The control means may be the plant's control system 240.

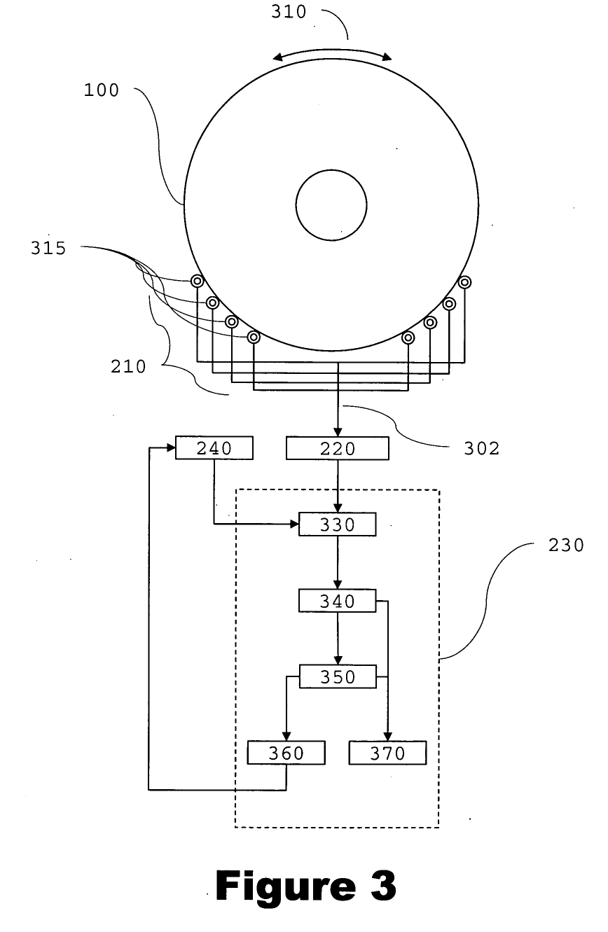

With reference to FIGS. 1, 2 and 3, sensor array 210 has from about 2 to about 16 acoustic sensors 315, with the actual number of sensors 315 depending on the size of the mill 100, with the sensors being located in the vicinity of the mill's outer shell in the load foot zone 190 of mill 100. Acoustic sensors 315 are of the flat response microphone-type, without any distortions in the frequency wave of interest. The microphones have an external high-resistant polymer casing and multiple lateral insulating layers to prevent interference from external acoustic noise when in operation. Acoustic sensors 315 may be of the active type (i.e., requiring electricity to operate), depending on the characteristics of each particular application. Likewise, the output signals from the sensor layout 210 may correspond to one or any combination of digital voltage, unbalanced analog voltage, balanced analog voltage, digital current, analog current (being the preferred embodiment), digital wireless, analog wireless, digital optical or analog optical.

The measurements provided by acoustic sensors 315 enter a signal conditioning means 220 comprising a plurality of amplifiers for one channel each, to amplify said signal and improve the signal-noise ratio, which serve to electrically insulate acoustic sensors 315 from the rest of the system, so that the sensors do not consume electricity; thus, the sound signal produced by mill 100 is not altered. In signal conditioning means 220 there is an independent amplifier for each acoustic sensor 315. Each amplifier is of the differential-type, to eliminate the noise induced by cables.

Signal conditioning means 220 may be an integral part of main unit 230 when main unit 230 is located close to the acoustic sensors 315, through a physical link up, such as by a length of cable or fiber optic cable. Alternatively, the communication can be via a wireless communications linkup. In the embodiment in which acoustic sensors 315 transmit wireless signals, signal conditioning means 220 includes a unit to receive said signals, upstream from the differential amplification stage of signal conditioning means 220. In another embodiment, signal conditioning means 220 is at site when there are cables connecting main unit 230 and the acoustic sensors 315 that have a length equal to or over 150 meters. In a preferred embodiment, signal conditioning means 220 is omitted.

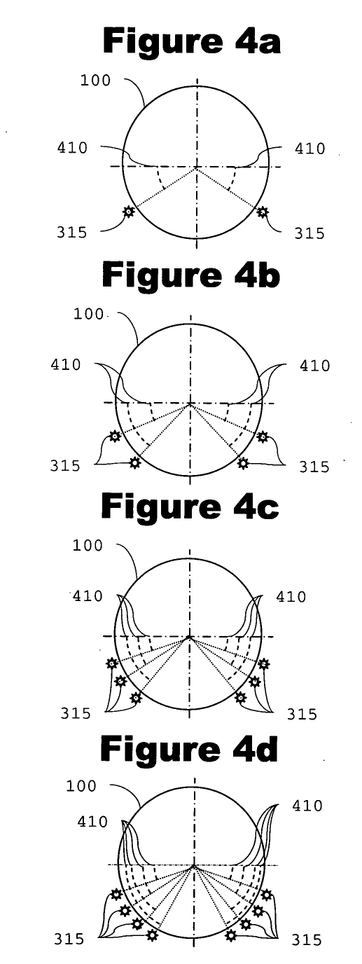

Sensor arrangement 210 is comprised of a set of acoustic sensors 315 symmetrically located at the load foot 190 of mill 100, so that the set is activated depending on the direction of the rotation 310 of mill 100. Each sensor arrangement 210 distributes the acoustic sensors 315 in a formation that may contain from one to four position angles 410 in the load foot zone of mill 100, as shown in FIGS. 4a-4d.

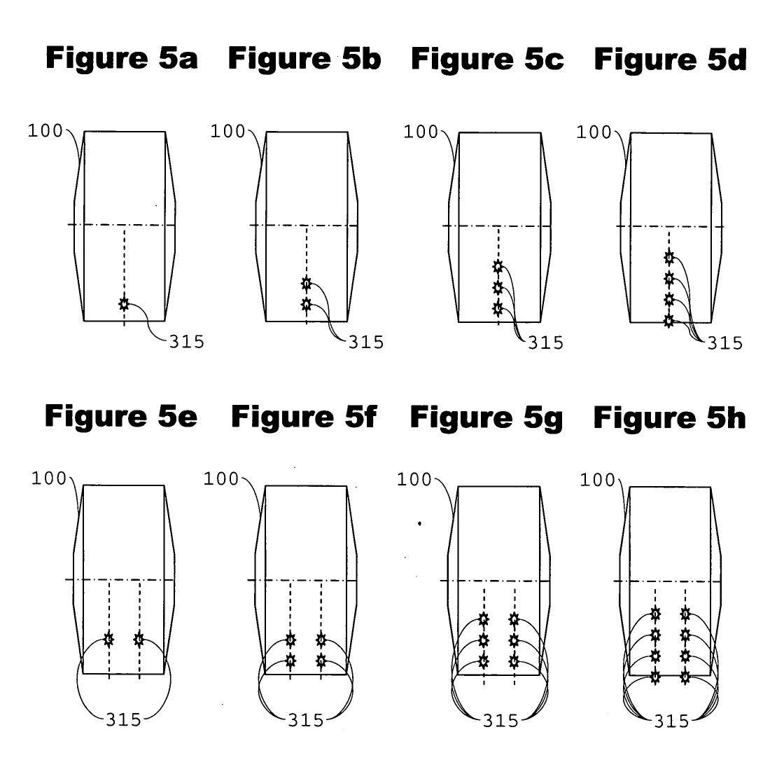

Depending on the number of acoustic sensors 315 required, they may be distributed on a column with from one to four acoustic sensors 315 for each sensor arrangement 210. If required by the size of mill 100, acoustic sensors 315 may be distributed on two columns for each sensor arrangement 210; all of this as shown in FIGS. 5a-5h.

Main unit 230 processes the sound signals according to the direction 310 mill 100 is rotating and generates, as output, one or more signals indicating the number and type of load impact against the internal lining 160 of mill 100. Main unit 230 may be located in a room suitable to contain electronic equipment or at site in the preferred embodiment.

When the mill 100 rotates in only one direction, the impact meter will only have the sensor array 210 located next to the load foot 190 corresponding to said turn direction 310.

A selecting means 330, is utilized to receive the signal from the active sensor array 210. This selection may be performed in at least three ways: (1) by electromechanical commutation (e.g. a relay), using a binary signal indicating the direction 310 of the mill 100, generated in the control system of the mill 100 and transmitted to the impact meter as an analog or digital signal; (2) by digital selection using the same signal of the direction of the mill turning, but with information from the program (software or firmware); and (3) by selecting the sensor array 210 active depending on the presence of impacts in the sound signal or mean maximum width thereof.

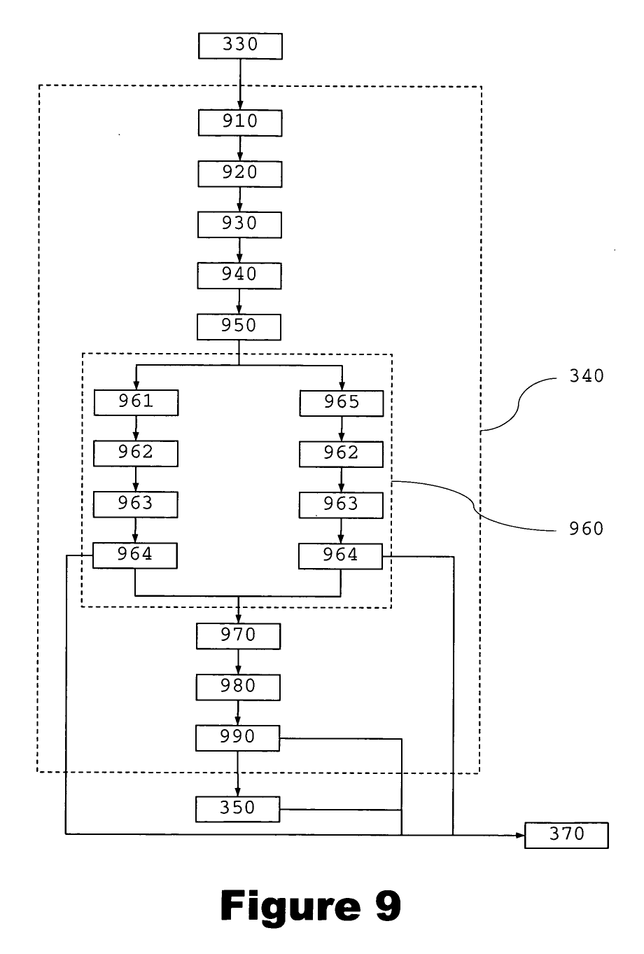

Once the sound signals from the load foot zone 190 in the mill 100 have been selected by the selection means 330 these signals are transmitted to a sensor signal analysis means 340. With reference to FIG. 9, the signal to be processed 920 is electrically isolated from the signal that was transmitted, the signal is amplified to an adequate level 930, according to the characteristics of each mill, and an anti-doubling filter 940 is applied in order to prevent the appearance therein of components of non-existing frequency.

The output signals from the anti-doubling filters 940 are digitized in an analog-to-digital converter 950. These digitized signals enter, as input data, an electronic processing unit 960 containing sensor mean signal analysis means 340. This processing unit 960 may be constructed on some of the following platforms, or in any combination thereof:

electronic analog circuits (in this case, the aforementioned analog/digital converter is not

included),

digital and/or optical microcontroller,

digital and/or optical microprocessor, and/or

digital and/or optical processor (preferred embodiment).

Processing unit 960 processes each one of the signals from the active sensor arrangement 210 located in front of the load foot 190 of the mill 100, after stages 330, 910, 920, 930, 940 and 950, in two different, independent and simultaneous processes.

The first process is intended to process the sound made by contact between rocky materials, where the signal 302 delivered by an acoustic sensor 315 is processed through a method comprising the following steps:

a) filtering the signal from an acoustic sensor 315 with a band pass filter 961 having adequate cut-off frequencies to highlight the sound caused by contact between rocky material within the mill 100;

b) converting the filtered signal into an equivalent power signal 962;

c) detecting the impacts on the power signal by pattern recognition 963. A preferred embodiment for this pattern recognition is the finding of temporary peaks of the power signal, with a duration below 10 milliseconds, where a integrated power greater than a threshold defined according to empirical testing during the calibration process accumulates; and

d) classifying impacts according to their power level 964.

The second process is intended to process sound caused by contact between metallic materials, where the signal delivered by an acoustic sensor 315 is processed through a method comprising the following steps:

a) filtering the signal from the same acoustic sensor 315 as in the first processing method with a band pass filter 965 having adequate cut-off frequencies to highlight the sound caused by contact between metallic materials within the mill 100;

b) converting the filtered signal into an equivalent power signal 962;

c) detecting the impacts on the power signal by pattern recognition 963. The preferred embodiment for this patter recognition is the finding of temporary peaks of the power signal, with a duration below 10 milliseconds, where a integrated power greater than a threshold defined according to empirical testing during the calibration process accumulates; and

d) classifying impacts according to their power level 964.

The electronic processing unit comprises means for performing a bi-dimensional classification of the power levels obtained from the sound signals highlighted in the two processes, where each process provides an axis for the analysis of said bi-dimensional classification.

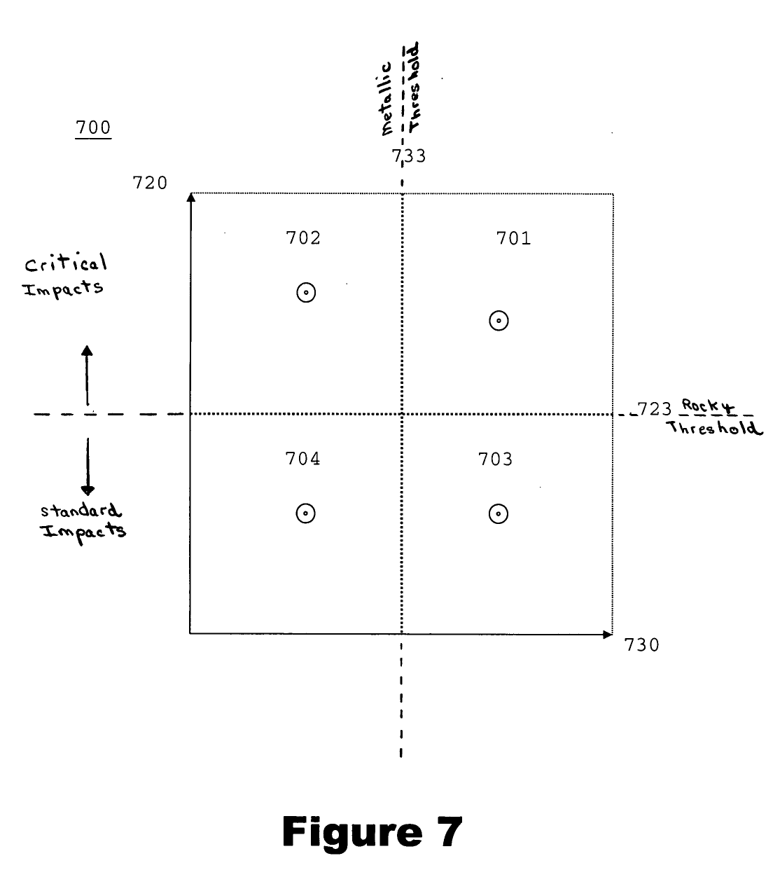

FIG. 7 shows the bi-dimensional classification 970 of the power levels obtained being made through a Cartesian classification diagram 700 of each impact (701, 702, 703 and 704), according to their power level where each one of the two processes provides an analysis axis, namely, vertical axis 270 for contacts between rocky materials, and horizontal axis 730 for contacts between metallic materials.

Once the contacts have been classified and accumulated in the Cartesian classification diagram 700, the count 980 of the accumulated impacts for each sensor is performed, for a pre-determined period of time on each quadrant in the Cartesian diagram 700 (one quadrant for each type 701, 702, 703 and 704 of impact). With the above, sensor outputs corresponding to the count 980 take place, through the adaptation to the proper format 990, before being presented to the user.

This by-sensor signal analysis means 340 sends out the values of their output variations by sensor, obtained from the bi-dimensional classification, to a display monitor 370 (optional) and to a weighted impact unifying means 350, this means provides representative values of the impacts as measured in the entire mill 100.

Once the output signals have been unified, they are transmitted to the appropriate digital/analog converting means 360 (only when the output signals from the by-sensor signal analysis means 340 are provided in digital format, to then be converted to one or more formats understandable to the operator and/or the plant's control system 240. Possible formats for the system's outputs may be one or a redundant, supplementary or complementary combination of:

a) Current analog

b) Voltage analog

c) Wireless analog

d) Optical analog

e) Current digital

f) Voltage digital (preferred embodiment)

g) Wireless digital

h) Optical digital

i) Monitor display 370

Some possible useful output variables of the movement of the load in the mill 100 are as follows:

a) impacts likely to correspond to a violent contact of massive metallic material against the internal lining 160 of the mill 100. According to the diagram in FIG. 7, they correspond to the accumulation of points 701 that are simultaneously above the Rocky Threshold 723 and to the right of the Metallic Threshold 733 (upper right quadrant);

b) impacts likely to correspond to a violent contact between metallic material of minor mass and large rocks against the internal lining 160 of the mill 100. According to the diagram in FIG. 7, they correspond to the accumulation of points (702 and 703) that are simultaneously above the Rocky Threshold 723 and to the left of the Metallic Threshold 733 (upper left quadrant), plus those are simultaneously below the Rocky Threshold 723 and to the right of the Metallic Threshold 733 (lower right quadrant);

c) impacts likely to correspond to the overturning action of the load itself, with rocks as well balls falling directly on the load foot 190, without hitting the internal lining 160. According to the diagram in FIG. 7, they correspond to the accumulation of points 704 that are simultaneously below the Rocky Threshold 723 and to the left of the Metallic Threshold 733 (lower left quadrant);

d) “Critical Impacts”, likely to correspond to a violent contact of massive metallic and rocky material against the internal lining 160 of mill 100. According to the diagram in FIG. 7, they correspond to the accumulation of points (701, 702) that are above the Rocky Threshold (upper quadrants);

e) “Standard Impacts”, likely to correspond to a violent contact of metallic and rocky material with minor mass against the internal lining 160 of the mill 100. According to the diagram in FIG. 7, they correspond to the accumulation of points (703, 704) that are below the Rocky Threshold 723 (lower quadrants);

A display monitor may be included to display data to the operator, displaying information on number of impacts by sensor, by filtering stage and by power level. Information related to the total accumulation of impacts, whether for all of the sensors and all power levels, or the display in text format of data on impacts with no more than four simultaneous value indicators, may be added. For example, it may show the value of “Critical Impacts” from all of the sensors altogether, and the value of “Standard Impacts” from all of the sensors, information that would be sufficient to use the equipment correctly.

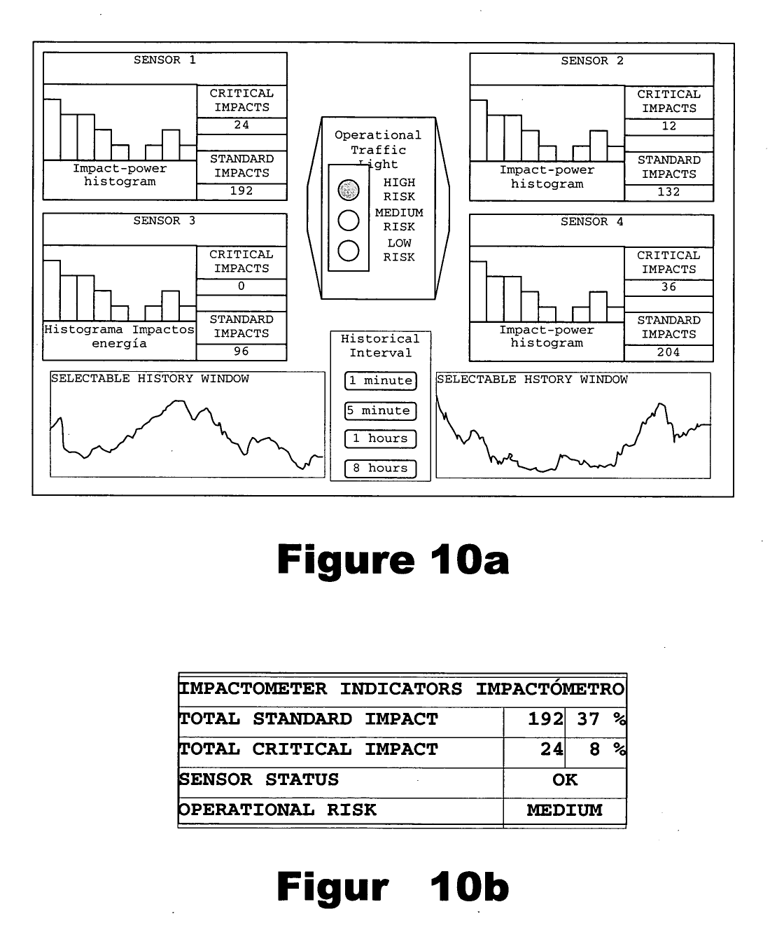

A preferred embodiment to show on a display monitor data from the impact meter is described in FIG. 10a. The display monitor in this preferred embodiment corresponds to the case of a four-sensor impact meter 315 on each side of the mill 100 arranged as shown in FIGS. 4b and 5f, and shows a chart for each sensor, on the left and right borders of the display monitor (same arrangement is in the mill, with the mill's feeding end to the right of the monitor, and the mill's discharge end to the right of the monitor), with detailed information on impact distribution based in power levels, where the power band for mineral filter or the power band for metallic filter may be chosen. Next to each one of these arrangements (four in the example), the latest values of Critical and Standards Impacts in each sensor are indicated. At the bottom of the monitor are two interactive historic graphs, for which the time range shown and the variable to be expressed in a graph may be chosen from command buttons and bar menus, respectively. Below, at the center, are seen the command buttons for selecting the time period to be shown as a graph of the historic data. At the display's center is an indicator of the instantaneous status of impact force (aggressiveness), similar to a traffic light, with a green light indicating the low occurrence of impacts, because of which it is possible to demand from the load motion more aggressiveness, an amber light to indicate medium risk as to the number of impacts, reason by which the operator should not demand more aggressiveness from the load motion, and a red light that informs the operator that he must immediately act on the mill's control variables to reduce the occurrence of impacts.

Another preferred embodiment is that shown in FIG. 10b, where minimum data are displayed for the correct operation of the equipment. Although this information does not permit a very deep analysis, it is conveniently simple for a less skilled operator to act immediately, does not mislead, and may be implemented with a monitor simpler and more suitable to an on-site application.

Should the impact meter not include a display monitor, the values of its output variables are shown on the control monitors of the plant's system. These variables are transmitted by the impact meter to the plant's control system through any of the aforementioned methods.

Control actions that a human or automatic operator may perform, with the information provided by the present invention, are intended to operate in the system before damage is caused on the mill or on the grinding means, or to prevent excessive undesired operating conditions to continue. The final outcome from the actions taken from observing the signals transmitted by the impact meter will depend on the operator's skills (or on the control measures implemented in the automatic system, in addition to the prevalence that may be assigned to the impact meter signals in connection with other operational variables of monitoring, such as power, pressure in the bearing oil, size of particles, among others.

If the impact meter output signals surpass a specific level (to be empirically determined at each plant), the operator should gradually reduce speed until the signals delivered by the equipment return to advisable levels (normally zero). Once its condition has been reached, the level of the volumetric mineral filling is increased, and the speed is increased again. These actions take place because the revolving speed of the mill (100) is a useful variable for the immediate control of impacts, whereas the level of volumetric filling is a mid-term control variable (of approximately one minute).

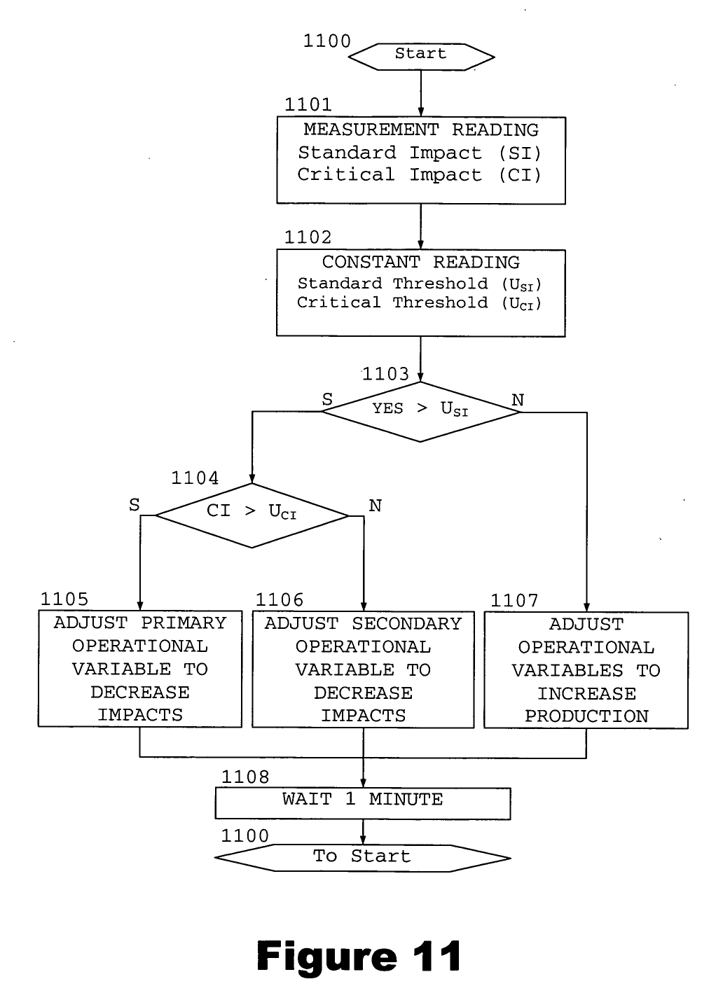

The operator may consider that in order to reduce the impacts, in general, one of the following actions may be taken: (1) reduce revolving speed (immediate action), (2) raise level of filling or mineral tonnage feed, i.e., increase the percentage of solids (short-term actions), (3) reduce granulometry (mid-term action), (4) reduce ball filling level (mid-term action) and (5) use lining parts with more inclined lifters (long-term action). According to each plant's operational policies, and to an evaluation carried out during the impact meter's start-up, the Primary Operational Variable and the Secondary Operational Variable are chosen from the Control flow diagram in FIG. 11. Likewise, constant values U_{SI} (action threshold to be compared to the time value of the Standard Impacts) and U_{CI} (action threshold to be compared to the time value of the Critical Impacts).

The general method in FIG. 11 allows the comparison of every minute 1108 of the last value of the standard thresholds provided by the impact meter 1101 and the fixed threshold value U_{SI} 1102 (understood a maximum allowed value). Should the value of the Standard Impacts be lower than the maximum allowed 1103, the operator may continue to normally operate, and even increase production demands 1107. Otherwise, should the value of standard impacts exceed the maximum allowed, the equivalent comparison between the value of Critical Impacts and fixed value U_{CI} 1104 (understood as a maximum value allowed) is to be made. If from the comparison, it turns out that the maximum level allowed for critical impacts 1105 has also been surpassed, action must be taken on the Primary Operational Variable (normally on the Rotation Speed one, since it yields the fastest results when trying to reduce the number of impacts. When the Critical Impacts are fewer than the maximum allowed 1106, action must be taken on the Secondary Operational Variable (normally on the level of Mill Filling), and the process must continue until both variables provided by the impact meter (Critical Impacts and Standard Impacts) are below their maximum allowed values (U_{CI} and U_{SI}, respectively).

There are many other control options that can employ the signals provided by the impact meter of the present invention, depending on the particular characteristics of each plant.

While there are shown and described present preferred embodiments of the invention, it is distinctly to be understood that the invention is not limited thereto, but may be otherwise variously embodied and practiced within the scope of the following claims.

We claim:

1. A system of measuring and classifying the impacts inside a revolving mill used in mineral grinding, the system comprising:
means to detect the impacts that occur inside the mill located near the load foot, which corresponds to the estimated contact position of the load in motion or the load cataract;
means to process the signals transmitted by the impact sensing means;
means to classify the impacts, according to their power level; and
control means to control the operation of the mill, according to the variables provided by the processing means, which correspond to the classification of the types of impacts occurring inside the mill.

2. The system of claim 1, wherein the impact sensing means comprises:
a first group of sensors, comprising at least one acoustic sensor located on the outside surface of the mill shell in the load foot zone, and a second group of sensors comprising at least one acoustic sensor located opposite the first group on the outside surface of the mill shell, in symmetry with a vertical or transverse axle of the mill; where only one group of sensors operates depending on the direction of the mill's rotation.

3. The system of claim 2, wherein the acoustic sensor is an active-type microphone.

4. The system of claim 2, wherein the acoustic sensor is a passive-type microphone.

5. The system of claim 2, wherein each of said first and second group of sensors have from 1 to about 8 acoustic sensors arranged in the load foot zone.

6. The system of claim 2, wherein the acoustic sensor is connected to an amplifier to improve the signal/noise ratio, electrically insulating the sensor from the rest of the system, so that no electric power is consumed from the sensor and the sound signal produced by the mill is not altered.

7. The system of claim 6, wherein the amplifier is of a differential type to eliminate ordinary noise induced by the cables.

8. The system of claim 7, wherein the processing means receives signals processed by the amplifier of each one of the acoustic sensors through a physical linkup.

9. The system of claim 8, wherein the processing means receives signals processed by the amplifier through a wireless linkup.

10. The system of claim 8, wherein the processing means is a main unit that processes the sound signals according to the direction of the mill motion, generating, as output, one or more signals indicating the number and types of impacts against the internal lining of the mill.

11. The system of claim 9, wherein the processing means is a main unit that processes the sound signals according to the direction of the mill, generating, as output, one or more signals indicating the number and type of load impacts against the internal lining of the mill.

12. The system of claim 10, wherein according to the direction of the mill motion, the main unit will only count the impacts detected by the group of sensors located next to the load foot corresponding to said direction of the turns

13. The system of claim 12, wherein the group of sensors is selected, through a selection means, by a turn direction signal.

14. The system of claim 13 wherein the group of sensors is selected, through a selection means, depending on the presence of impacts on the sound signals in one of the groups.

15. The system of claim 14, wherein the sound signals selected are sent to a means of by-sensor signal analysis where ordinary induced noise is eliminated and then is amplified to the adequate level and an anti-doubling filter is applied to prevent the appearance of components of non-existing frequencies when digitizing a signal.

16. The system of claim 15, wherein each digitized output signal from the anti-doubling filter enters as input data into an electronic processing unit contained as a by-sensor signal analysis means.

17. The system of claim 16, wherein the electronic unit applies to each one of the signals from the sensors a first and second different, independent and simultaneous process.

18. The system of claim 17, wherein the first process is intended to highlight the sound caused by the contact of rocky materials within the mill.

19. The system of claim 18, wherein the second process is intended to highlight the noise caused by metallic materials within the mill.

20. The system of claim 19, wherein the electronic processing unit comprises the means to classify the impacts according to their power levels obtained from the sound signals highlighted by said first process and said second process, where each process provides an analysis axis for said classification, with which a bi-dimensional classification is established.

21. The system of claim 20, wherein the signal analysis by-sensor means sends out the values obtained from the bi-dimensional classification in a format understandable to the mill operator or the control system.

22. The system of claim 21, further comprising a display monitor to represent the values obtained in the bi-dimensional classification.

23. The system of claim 22, wherein the control means, to control the operation of the mill, receives the values obtained in the bi-dimensional classification to operate automatically.

24. The system of claim 22, wherein the values shown on said display monitor allow the operator to suitably adjust the mill's rotating speed.

25. The system of claim 22, wherein the values shown on said display monitor allow the operator to suitably adjust the level of volumetric mineral filling.

26. The system of claim 22, wherein the values shown on said display monitor allow the operator to suitably adjust the mineral tonnage feed to the mineral mill.

27. The system of claim 22, wherein the values shown on said display monitor allow the operator to suitably adjust the percentage of solids in the mill's mineral load.

28. The system of claim 22, wherein the values shown on said display monitor allow the operator to suitably adjust the level of ball filling.

29. A method of measuring, classifying and controlling impacts inside a rotating mill used in mineral grinding, a method comprising the steps of:
(a) detecting the impacts occurring inside the mill, through an acoustic sensing means, near the load foot, corresponding to the estimated position of the contact of the load in motion or load cataract;
(b) processing the signals provided by the impact sensing means through a processing means;
(c) classifying the impacts according to their power level; and
(d) controlling the operation of the mill through a control means according to the variables provided by the processing means, which correspond to the classification of types of impacts detected occurring inside the mill.

30. The method of claim 29, wherein the impact sensing means is comprised of:
a first group of sensors, which has at least one acoustic sensor, located on the surface of the mill shell, in the load foot zone, and a second group of sensors located opposite first group on the surface of the mill shell, in symmetry with the mill's vertical or transverse axle;
where only one group of sensors is operating for each revolving direction of the mill.

31. The method of claim 30, wherein the at least one acoustic sensor is an active-type microphone.

32. The method of claim 30, wherein the at least one acoustic sensor is a passive-type microphone.

33. The method of claim 30, wherein said first or second group of sensors has from one to about eight acoustic sensors installed in the load foot zone.

34. The method of claim 30, wherein the at least one acoustic sensor is connected to an amplifier to improve the signal/noise ratio, electrically insulating the sensor from the rest of the system, so that the sound signal produced by the mill is not altered.

35. The method of claim 34, wherein the amplifier is of a differential type, to eliminate normal noise induced by the cables.

36. The method of claim 35, wherein the processing means receives the signals processed by the amplifier from each acoustic sensor through a physical linkup.

37. The method of claim 35, wherein the processing means receives the signals processed by the amplifier from each sensor through a wireless linkup.

38. The method of claim 29, wherein the processing step includes the steps of:
processing the sound signals according to the direction of the mill motion; and
generating, as output, one or more signals indicating the number and types of impacts of the load against the internal lining of the mill.

39. The method of claim 38, wherein, according to the direction of the motion of the mill, the main unit will only count the impacts detected by the group of sensors located next to the load foot corresponding to said motion direction.

40. The method of claim 39, wherein the group of sensors is selected by a signal of the direction of the motion generated by the mill's control.

41. The method of claim 40, wherein the group of sensors is selected according to the presence of impacts on the sound signal in one of the groups.

42. The method 41, further comprising the steps of:
sending said signals to a by sensor signal analysis means;
eliminating the induced noise in common mode and electronically insulating the signal to be processed;
amplifying to an adequate level; and
applying an anti-doubling filter to prevent the appearance of signals of non-existing components when digitizing a signal.

43. The method of claim 42, wherein each filtered output signal from the anti-doubling filter enters as input data into an electronic processing unit contained in a by-sensor signal analysis means.

44. The method of claim 43, wherein the electronic processing unit applies to each signal from the sensors two different, independent and simultaneous processes

45. The method of claim 44, wherein the first process comprises the steps of:
filtering the signal from an acoustic sensor with a band pass filter having adequate cut-off frequencies to highlight the sound caused by contact between rocky material within the mill;
converting the filtered signal into an equivalent power signal;
detecting the impacts on the power signal by pattern recognition; and
classifying impacts according to their power level.

46. The method of claim 44, wherein the second process comprises the steps of:
filtering the signal from the same acoustic sensor with a band pass filter having adequate cut-off frequencies to highlight the sound caused by contact between metallic materials within the mill;
converting the filtered signal into an equivalent power signal;
detecting the impacts on the power signal by pattern recognition; and
classifying impacts according to their power level.

47. The method of claim 45, wherein the acoustic sensor is the same for the two processes.

48. The method of claim 46, wherein the acoustic sensor is the same for the two processes.

49. The method of claim 47, wherein in the step of detecting the impacts on the power signal through pattern recognition in the two processes, said recognition is performed by finding temporary peaks in the power signal with a duration below 10 milliseconds, in each of which the integrated energy accumulated over a threshold defined during the calibration process.

50. The method of claim 47, further including the steps of performing a bi-dimensional classification of impacts with the power levels obtained from the sound signals highlighted by said first process and said second process, where the first process provides an vertical analysis axis for contacts between rocky material and the second process provides a horizontal axis for contacts between metallic material, of said bi-dimensional classification.

51. The method of claim 50, wherein impacts from a violent contact of massive metallic material against the internal lining of the mill correspond to the accumulation of points that are in an area that corresponds to the upper right quadrant of the bi-dimensional classification.

52. The method of claim 50, wherein impacts from a violent contact between metallic material of minor mass and large rocks against the internal lining of the mill correspond to the accumulation of points that are in an area that corresponds to the upper right quadrant of the bi-dimensional classification; plus those that are in an area that corresponds to the lower right quadrant of the bi-dimensional classification.

53. The method of claim 50, wherein impacts from the overturning action of the load itself, with rocks as well balls falling directly on the load foot without hitting the internal lining, corresponding to the accumulation of points that are in an area that corresponds to the lower left quadrant of the bi-dimensional classification;

54. The method of claim 50, wherein “Critical Impacts” from a violent contact of massive metallic and rocky material against the internal lining of the mill, correspond to the accumulation of points that are in an area that corresponds to the upper quadrants of the bi-dimensional classification.

55. A method of claim 50, wherein “Standard Impacts” from a violent contact of metallic and rocky material with minor mass against the internal lining of the mill, correspond to the accumulation of points that are in an area that corresponds to the lower quadrants of the bi-dimensional classification.

56. The method of claim 50, wherein the impact values obtained in the bi-dimensional classification are provided in a format understandable to the operator or the mill's control system.

57. The method of claim 56, wherein the values obtained in the bi-dimensional classification are presented in the display monitor.

58. The method of claim 57, wherein the step of controlling the operation of the mill receives the values obtained in the bi-dimensional classification to operate automatically.

59. The method of claim 58, wherein the values shown on the display monitor allow the operator to suitably adjust the mill's rotating speed.

60. The method of claim 59, wherein the values shown on the display monitor allow the operator to suitably adjust the level of volumetric mineral filling.

61. The method of claim 60, wherein the values shown on the display monitor allow the operator to suitably adjust the tonnage of mineral feed to the mineral mill.

62. The method of claim 61, wherein the values shown on the display monitor allow the operator to suitably adjust the percentage of solids in the load of the mineral mill.

63. The method of claim 62, wherein the values shown on the display monitor allow the operator to suitably adjust the level of ball filling.
